(19) United States
(12) Patent Application Publication
(10) Pub. No.: US 2026/0010797 A1
(43) Pub. Date: Jan. 8, 2026

(54) METHOD FOR MANAGING KV CACHE IN TRANSFORMER MODEL BASED ON REINFORCEMENT LEARNING, AND APPARATUS THEREFOR

(71) Applicant: SAMSUNG SDS CO., LTD., Seoul (KR)

(72) Inventors: Kihyo MOON, Seoul (KR); Sukhoon JUNG, Seoul (KR); Sungyoon KIM, Seoul (KR); Youngjun KIM, Seoul (KR)

(73) Assignee: SAMSUNG SDS CO., LTD., Seoul (KR)

(21) Appl. No.: 19/203,352

(22) Filed: May 9, 2025

(30) Foreign Application Priority Data
Jul. 3, 2024 (KR) 10-2024-0087583
Oct. 18, 2024 (KR) 10-2024-0143244

(51) Int. Cl. G06N 3/092; G06F 12/0871; G06N 3/045

(52) U.S. Cl. CPC G06N 3/092; G06F 12/0871; G06N 3/045

(57) ABSTRACT

The disclosure is intended to efficiently allocate the KV cache by predicting the length of an output token sequence (or the number of tokens) of the transformer model according to an input prompt (or input token sequence) through a neural network model, thereby efficiently utilizing the limited memory of a processor such as a GPU or the like. According to the disclosure, there is provided a method, performed in a computing device, for managing a KV cache for operation of a transformer model, and the method may include: training a KV cache manager comprising a neural network, based on a plurality of input prompts of the transformer model and an output sequence of the transformer model for each input prompt; predicting, by the trained KV cache manager, based on a first input prompt of the transformer model, the number of tokens to be included in a first output sequence of the transformer model for the first input prompt; and determining a size of a KV cache for the first input prompt, based on the predicted number of tokens.

### CROSS-REFERENCE TO RELATED APPLICATION(S)

This application is based on and claims priority under 35 U.S.C. 119 to Korean Patent Applications No. 10-2024-0087583, filed on Jul. 3, 2024 and No. 10-2024-0143244, filed on Oct. 18, 2024, in the Korean Intellectual Property Office, the disclosure of which is herein incorporated by reference in its entirety.

### BACKGROUND OF THE INVENTION

### 1. Field of the Invention

The disclosure relates to generative AI (hereinafter referred to as “Gen AI”) and, more specifically, to a Transformer model that is an attention-based sequence transduction neural network model for implementing Gen AI.

### 2. Description of the Prior Art

In 2017, Ashish Vaswani et al. of Google Brain proposed the Transformer model, which is an attention-based sequence transduction neural network model, in a paper titled “Attention Is All You Need.” This model dramatically improved the problems of previous RNN (Recurrent Neural Network) models, and since then, the transformer model has been considered as the de facto standard for implementing large language models (LLMs).

Until recently, various LLMs based on the transformer model, such as OpenAI's ChatGPT, Google's Bard, Meta's LLAMA, Stanford University's Alpaca, and LMSYS.org's Vicuna, have been announced. The transformer model proposes an encoder-decoder structure, an encoder-only structure such as BERT, and a decoder-only structure such as GPT and LLAMA, as presented in Google's paper in 2017.

In order to perform calculation of self-attention, which is one of the core technologies of the transformer model, the operation of the query, key, and value tensors obtained based on input tokens must be performed repeatedly every time step.

For example, in the inference process of the decoder-based LLM, in order to obtain an output token at a specific time step t, one token with the highest probability of appearance is predicted based on the tokens up to a time step t−1 and generated as an output token, and the generated output token is input to generate an output token of the next time step. This process is repeated until the <eos> token is obtained, and this model is called an auto-regressive model. In this process, the operations of the query, key, and value tensors are repeatedly performed to calculate self-attention.

In general, the LLM (or transformer model) has a large context window size, and KV cache technology is applied to reduce the amount of computation by storing the key/value tensors calculated in the output token generation process of the LLM in the memory of a GPU or the like and reusing the same such that the key/value tensors of previous tokens are prevented from being recalculated.

However, KV cache has the problem of increasing memory usage because it must store the generated key and value tensors without discarding them while reducing the amount of computation. The amount of memory required for KV caching is determined by the context window size and batch size.

FIG. 1 is a schematic diagram illustrating a configuration in which a KV cache is allocated to a memory 40 in the prior art. The primary issue in allocating a KV cache to the memory 40 for processing various prompts input to an LLM is that the length of the input and output token sequences varies depending on the case, so it is impossible to know exactly the amount of memory to be actually used. Therefore, the areas 50, 60, 70, and 80 of the memory 40 must always be configured with sufficient margin.

In addition, since the LLM must be able to process multiple prompts (or input token sequences) in parallel as one batch, a KV cache must also be allocated to each of the multiple prompts to be processed in parallel. Therefore, the memory area 50, 60, 70, or 80 for each KV cache is configured to the maximum size (e.g., 1024 slots as shown in FIG. 1) set through the parameters of the corresponding LIM.

FIG. 1 shows, for example, the memory areas 50, 60, 70, and 80 allocated for the KV caches corresponding to the respective prompts (i.e., prompt \textcircled{1} to prompt \textcircled{4}) for processing four prompts in parallel as one batch, and the memory area indicated by hatching in FIG. 1 shows the area actually used for the KV cache in processing each prompt. In the example, a total of 73.5% of memory fragmentation occurred in the remaining unused areas 52, 62, 72, and 82, and accordingly, the total memory usage rate was only 26.5%. Thus, there is a problem in which the waste of memory per prompt can be very severe.

### SUMMARY OF THE INVENTION

The disclosure is intended to efficiently allocate the KV cache by predicting the length of an output token sequence (or the number of tokens) of the transformer model according to an input prompt (or input token sequence) through a neural network model, thereby efficiently utilizing the limited memory of processors such as GPUs.

In addition, the disclosure is to improve the performance (throughput) of LLM serving by increasing the number of prompts in one batch that the LLM can process in parallel with the same memory size through efficient allocation of the KV cache to the memory.

In addition, the disclosure is to present a reinforcement learning model capable of accurately predicting the length of an output token sequence (or the number of tokens) of the transformer model according to an input prompt for efficient allocation of the KV cache to the memory.

In addition, the disclosure is to predict the minimum KV cache size necessary for the operation of the transformer model, thereby solving problems such as memory fragmentation and maximizing memory utilization.

In addition, the disclosure is to propose a method for configuring and managing a buffer area when applying a prediction technique to the length of an output token sequence (or the number of tokens) of the transformer model according to an input prompt using a proposed neural network model, thereby ensuring stable operation of the transformer model while efficiently using limited memory.

Furthermore, the disclosure is to propose a method for handling exceptions in the case where a prediction is inaccurate when applying a prediction technique to the length of an output token sequence (or the number of tokens) of the transformer model according to an input prompt using a proposed neural network model, thereby ensuring stable operation of the transformer model while efficiently using limited memory.

The technical problems to be solved in the disclosure are not limited to the technical problems mentioned above, and other technical problems not mentioned will be clearly understood by those skilled in the art to which the disclosure belongs from the description in this specification.

In the first aspect of the disclosure, there is provided a method, performed in a computing device, for managing a KV cache for operation of a transformer model, and the method may include: training a KV cache manager including a neural network, based on a plurality of input prompts of the transformer model and an output sequence of the transformer model for each input prompt; predicting, by the trained KV cache manager, based on a first input prompt of the transformer model, the number of tokens to be included in a first output sequence of the transformer model for the first input prompt; and determining a size of a KV cache for the first input prompt, based on the predicted number of tokens.

Here, the training may be performed such that a difference between the number of tokens of the output sequence predicted by the KV cache manager for each of the plurality of input prompts of the transformer model and the number of tokens of the output sequence of the transformer model actually output is reduced.

In addition, the training may include determining a reward, based on a difference between the number of tokens of the output sequence predicted by the KV cache manager for each of the plurality of input prompts of the transformer model and the number of tokens of the output sequence of the transformer model actually output, and training the neural network using reinforcement learning, based on the reward.

In addition, an embodiment of the method of the present disclosure may further include further training the KV cache manager, based on the difference between the number of tokens predicted by the KV cache manager for the first input prompt and the number of tokens included in the first output sequence actually output by the transformer model.

In addition, an embodiment of the method of the present disclosure may further include allocating a memory area corresponding to the KV cache for the first input prompt, based on the determined size of the KV cache, and the memory area may include a buffer area.

Here, the size of the buffer area may be variably adjusted based on a difference between the number of tokens predicted by the KV cache manager up to a previous step of a current step and the number of tokens included in an output sequence actually output by the transformer model.

In addition, an embodiment of the method of the present disclosure may further include: allocating a memory area for the KV cache for the first input prompt, based on the determined size of the KV cache; and further allocating a predetermined area of the memory in a case where the number of tokens included in the first output sequence actually output by the transformer model for the first input prompt exceeds the number of tokens predicted by the KV cache manager and where the allocated memory area is insufficient.

In addition, an embodiment of the method of the present disclosure may further include: predicting, by the trained KV cache manager, based on a second input prompt of the transformer model, the number of tokens to be included in a second output sequence of the transformer model for the second input prompt; determining a size of a KV cache for the second input prompt, based on the predicted number of tokens; allocating a memory area for each of the KV cache for the first input prompt and the KV cache for the second input prompt, based on the determined sizes thereof; and causing the transformer model to process the first input prompt and the second input prompt in parallel.

In the second aspect of the disclosure, there is provided an apparatus including: a processor; and a memory, and the memory may include instructions configured to cause, when executed by the processor, the apparatus to implement specific operations for managing a KV cache for operation of a transformer model, and the specific operations may include: training a KV cache manager including a neural network, based on a plurality of input prompts of the transformer model and an output sequence of the transformer model for each input prompt; predicting, by the trained KV cache manager, based on a first input prompt of the transformer model, the number of tokens to be included in a first output sequence of the transformer model for the first input prompt; and determining a size of a KV cache for the first input prompt, based on the predicted number of tokens.

According to the disclosure, it is possible to efficiently utilize the limited memory of processors such as GPUs by efficiently allocate the KV cache by predicting the length of an output token sequence (or the number of tokens) of the transformer model according to an input prompt (or input token sequence) through a neural network model.

In addition, according to the disclosure, it is possible to improve the performance (throughput) of LLM serving by increasing the number of prompts in one batch that the LLM can process in parallel with the same memory size through efficient allocation of the KV cache to the memory.

In addition, according to the disclosure, it is possible to implement a reinforcement learning model capable of accurately predicting the length of an output token sequence (or the number of tokens) of the transformer model according to an input prompt for efficient allocation of the KV cache to the memory.

In addition, according to the disclosure, it is possible to solve problems such as memory fragmentation and maximize memory utilization by predicting the minimum KV cache size necessary for the operation of the transformer model.

In addition, according to the disclosure, it is possible to ensure stable operation of the transformer model while efficiently using the limited memory by proposing a method for configuring and managing a buffer area when applying a prediction technique to the length of an output token sequence (or the number of tokens) of the transformer model according to an input prompt using a proposed neural network model.

Furthermore, according to the disclosure, it is possible to ensure stable operation of the transformer model while efficiently using the limited memory by proposing a method for handling exceptions in the case where a prediction is inaccurate when applying a prediction technique to the length of an output token sequence (or the number of tokens) of the transformer model according to an input prompt using a proposed neural network model.

The effects obtainable from the disclosure are not limited to the effects mentioned above, and other effects that are not mentioned will be clearly understood by those skilled in the art to which the disclosure belongs from the description in this specification.

### BRIEF DESCRIPTION OF THE DRAWINGS

The attached drawings are included as part of the detailed description to help understanding of the disclosure and illustrate embodiments and technical features of the disclosure together with the detailed description.

FIG. 1 is a schematic diagram illustrating a configuration in which a KV cache is allocated to a memory 40 in the prior art.

FIG. 2 is a schematic diagram illustrating a reinforcement learning model 200 of an agent 210 according to an embodiment of the disclosure.

FIG. 3 is a diagram illustrating an embodiment of a reinforcement learning process of a KV cache manager 300 corresponding to an agent 210 in the reinforcement learning model 200 in FIG. 2.

FIG. 4 is a schematic diagram illustrating the function of a KV cache manager 300 trained according to a reinforcement learning process in the embodiment of the disclosure described above.

FIG. 5 is a diagram illustrating an embodiment of an inference and additional reinforcement learning process of a KV cache manager 300 trained through the reinforcement learning process illustrated in FIG. 3.

FIG. 6 is a schematic diagram illustrating a state in which a KV cache is allocated to a memory of a GPU or the like according to an embodiment of the disclosure.

FIG. 7 illustrates an apparatus capable of performing the proposed method of the disclosure.

### DETAILED DESCRIPTION OF THE EXEMPLARY EMBODIMENTS

The disclosure may be transformed into various forms and may have various embodiments. Hereinafter, specific embodiments will be described in detail with reference to the attached drawings. The following embodiments are provided to help a comprehensive understanding of the method, apparatus, system, and/or storage medium described in this specification. However, these are merely examples, and the scope of the disclosure is not limited thereto.

When describing the embodiments of the disclosure, a specific description of a known technology related to the disclosure, which may obscure the subject matter of the disclosure, will be omitted. In addition, the terms described below are terms defined in consideration of their functions in the disclosure, and these may vary depending on the intention or custom of the user or operator. Therefore, the definitions should be made based on the description throughout this specification. The terms used in the detailed description are only intended to describe the embodiments of the disclosure, and should not be construed to limit the disclosure. Unless clearly used otherwise, the singular expression form includes the plural expression form. In this description, expressions such as “include” or “be provided with” are intended to indicate certain characteristics, numbers, steps, operations, elements, or parts or combinations thereof, and should not be construed to exclude the presence or possibility of one or more other characteristics, numbers, steps, operations, elements, or parts or combinations thereof.

Although “first,” “second,” etc. may be used to described various components, the components are not limited to such terms, and the terms are used only for the purpose of distinguishing one component from another.

### Reinforcement Learning of KV Cache Manager

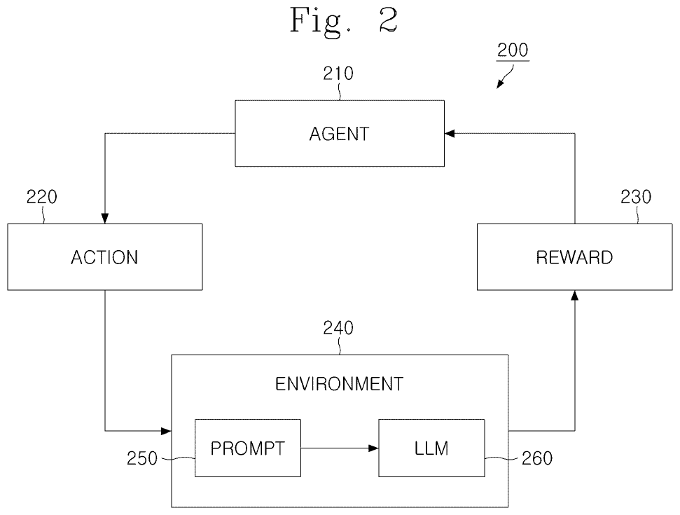

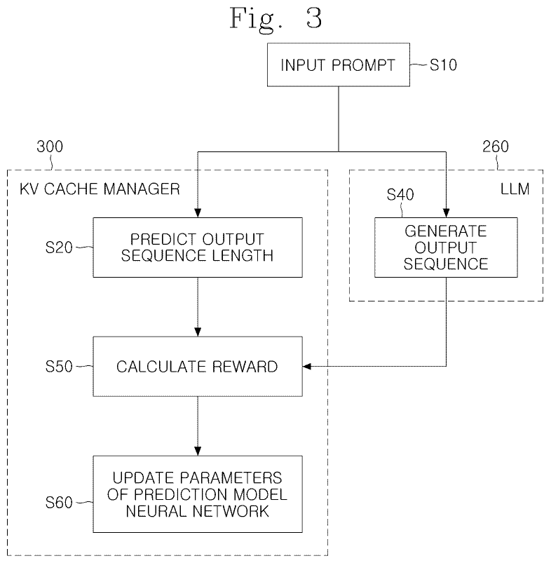

FIG. 2 is a schematic diagram illustrating a reinforcement learning model 200 of an agent 210 for effective allocation of a KV cache according to an embodiment of the disclosure. In the illustrated reinforcement learning model 200, the agent 210 is generally an entity that actually performs learning, and indicates a subject that selects and executes an action 220 in an environment 240. In this embodiment, the agent 210 may be a KV cache manager 300 illustrated in FIG. 3.

Furthermore, the environment 240 indicates an environment in which the agent 210 performs an action 220 to have interactions, and in this embodiment, the environment 240 may be an LLM 260 into which a prompt 250 is input. Here, the LLM 260 may be a transformer model.

In addition, the action 220 indicates the action actually performed by the agent 210, and in this embodiment, the action 220 indicates that the agent 210 predicts the length of an output token sequence (or the number of tokens). A reward 230 indicates the reward that the agent 210 receives by performing a certain action 220. A high reward is given for a desirable action that helps attain the goal, and a low reward is given for an inappropriate action.

FIG. 3 is a diagram illustrating an embodiment of a reinforcement learning process of the KV cache manager 300. In this embodiment, the KV cache manager 300 shown in FIG. 3 may correspond to the agent 210 shown in FIG. 2. When an input prompt 250 for an LLM 260 is input (S10), the KV cache manager 300 predicts the length of an output token sequence (or the number of tokens) for the input prompt 250, based on a neural network (S20). Here, in the initial stage of the reinforcement learning illustrated, one value may be randomly selected, as an initial value of prediction values of the KV cache manager 300 for the length of the output token sequence (or the number of tokens) for the input prompt 250, from among the values between the maximum output token (i.e., max_output_token) configured as a parameter of the LIM 260 and 1.

In addition, when the LLM 260 generates an output token sequence, based on the prompt 250 (S40), a reward 230 is calculated based on a predicted value A for the length of the output token sequence (or the number of tokens) predicted by the KV cache manager 300 and a length B of the output token sequence (or the number of tokens) actually generated by the LLM 260 (S50).

The reward 230 may be determined to increase as the difference between A and B decreases, and conversely, to decrease as the difference between A and B increases. The learning of the neural network model included in the KV cache manager 300 corresponding to the agent 210 is performed so that the KV cache manager 300 selects an action for receiving a high reward, that is, so that the length of the output sequence (or the number of tokens) is predicted such that the difference between A and B decreases.

Here, for example, the following score value may be used to calculate the reward 230.

$$Score = max ( \vert A \vert , \vert B \vert ) / max ( \vert A - B \vert , 1 )$$

The KV cache manager 300, which is the agent 210, may update parameter values of the prediction model neural network such that the score value described above increases (S60), which indicates that the difference between A and B decreases.

In the subsequent iteration process, the KV cache manager 300 predicts the length of an output token sequence (or the number of tokens), based on the next input prompt 250 (S20), and when the LLM 260 generates the output token sequence, based on the corresponding input prompt 250 (S40), a reward 230 is calculated based on a predicted value A for the length of the output token sequence (or the number of tokens) predicted by the KV cache manager 300 and a length B of the output token sequence (or the number of tokens) actually generated by the LLM 260 (S50), and the KV cache manager 300 updates the parameter values of the prediction model neural network again such that the score value above increases (S60). As these processes are continuously repeated, reinforcement learning of the KV cache manager 300, which is the agent 210, is performed.

### Functions of Trained KV Cache Manager

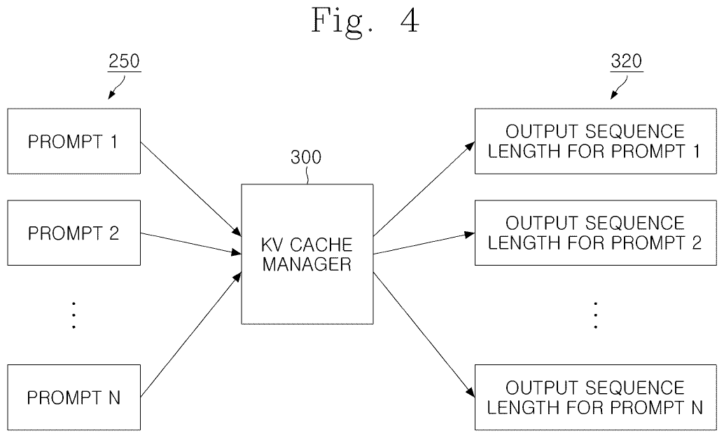

FIG. 4 is a schematic diagram illustrating the function of a KV cache manager 300 trained according to a reinforcement learning process in the embodiment of the disclosure described above. The trained KV cache manager 300 according to the embodiment may perform a function of predicting the length of an output token sequence (or the number of tokens) to be output by the LLM 260 for each input prompt 250.

For example, in the case where the length of an input prompt (or the number of tokens constituting the input token sequence) input to the LLM 260 is L and where the length of an output token sequence (or the number of tokens) of the LLM 260 therefor is M, the size of a KV cache to be allocated to the corresponding input prompt may be expressed as a function value f(L+M). Here, the function f(·) varies depending on the size and type of the LLM 260 (e.g., a hidden state size, the number of layers, quantization, etc.), so f(L+M), which is the size of a KV cache to be allocated, is not only proportional to L+M, but also varies depending on the content of the input prompt, making it difficult to predict.

Therefore, in the disclosure, the KV cache manager 300, which is an agent 210 trained through reinforcement learning, may accurately predict the size of the KV cache required to process a specific input prompt, thereby solving problems such as memory fragmentation and reducing wasted space in the memory. According to this embodiment, the KV cache manager 300 trained through reinforcement learning may have adaptive characteristics to respectively LLMs 260, and may be configured to accurately predict the size of the KV cache corresponding to a specific input prompt and further perform a function of scheduling the corresponding KV cache to be efficiently allocated to an appropriate location in the memory.

### Inference Process and Additional Learning of Trained KV Cache Manager

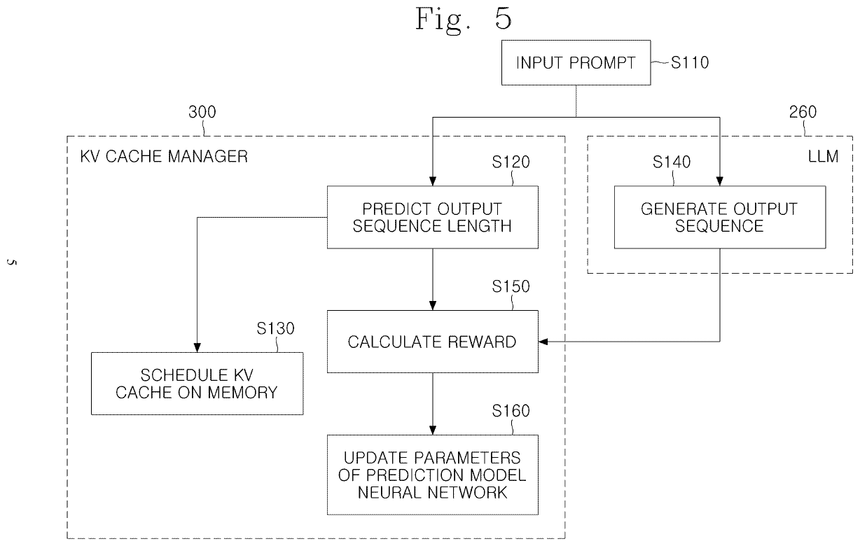

FIG. 5 is a diagram illustrating an embodiment of performing an inference and additional reinforcement learning process by putting a KV cache manager 300 pre-trained through the reinforcement learning process exemplified in FIG. 3 into the serving of the LLM 260. As described with reference to FIG. 3, when an input prompt 250 is input (S110), the KV cache manager 300 predicts the length of an output token sequence (or the number of tokens) for an input prompt 250, based on the trained neural network (S120).

Meanwhile, the KV cache manager 300 schedules the KV cache on the memory, based on the predicted length of the output token sequence (or the number of tokens) (S130).

In addition, when the LLM 260 generates an output token sequence, based on the prompt 250 (S140), a reward 230 is calculated based on a predicted value A for the length of the output token sequence (or the number of tokens) predicted by the KV cache manager 300 and a length B of the output token sequence (or the number of tokens) actually generated by the LLM 260 (S150).

The reward 230 may be determined to increase as the difference between A and B decreases, and to decrease as the difference between A and B increases. Further learning of the neural network model included in the KV cache manager 300 corresponding to the agent 210 is performed so that the KV cache manager 300 selects an action for receiving a high reward, that is, so that the length of the output token sequence (or the number of tokens) is predicted such that the difference between A and B decreases (S160).

In addition, in the process of scheduling (S130) the KV cache on the memory, based on the length of the output to ken sequence (or the number of tokens) predicted by the KV cache manager 300, the KV cache manager 300 may allocate the KV cache to an appropriate location on the memory of a GPU or the like with an appropriate size so as to be used in the operation process of the LLM 260.

### KV Cache Scheduling, Buffer Area Management, and Exception Handling on Memory

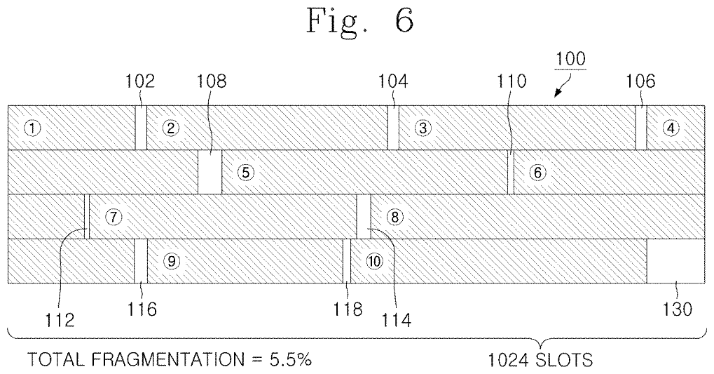

FIG. 6 is a schematic diagram illustrating a state in which a KV cache is allocated to a memory of a GPU or the like according to an embodiment of the disclosure. For example, based on the size of a KV cache determined based on the length of an output token sequence (or the number of tokens) predicted by the KV cache manager 300 for a first input prompt, the memory area \textcircled{1} for a KV cache with respect to the first input prompt is allocated to the memory of a GPU or the like, as shown in the drawing (hatching area).

Following the same process, the memory area \textcircled{2} for a KV cache with respect to a second input prompt, the memory area \textcircled{3} for a KV cache with respect to a third input prompt, the memory area \textcircled{4} for a KV cache with respect to a fourth input prompt, the memory area \textcircled{5} for a KV cache with respect to a fifth input prompt, the memory area \textcircled{6} for a KV cache with respect to a sixth input prompt, the memory area \textcircled{7} for a KV cache with respect to a seventh input prompt, the memory area \textcircled{8} for a KV cache with respect to an eighth input prompt, the memory area \textcircled{9} for a KV cache with respect to a ninth input prompt, and the memory area \textcircled{10} for a KV cache with respect to a tenth input prompt are allocated as shown in the drawings.

Here, the memory areas \textcircled{1} to \textcircled{10} for the KV caches with respect to the respective input prompts may further include buffer areas 102, 104, 106, 108, 110, 112, 114, 116, and 118 therebetween. The size of the buffer area may be variably adjusted based on the difference between the number of tokens predicted by the KV cache manager 300 up to the previous step N−1 of the current step N and the number of tokens included in an output sequence actually output by the LIM 260.

For example, in the case where the size of the buffer area described above is ε, ε may be determined according to the following equation.

$$ε = {ε}_{N} = ( \frac{{\sum }_{i = 1}^{i = N - 1} \vert {A}_{i} - {B}_{i} \vert}{N - 1} ) \cdot 1.1$$

Here, Aᵢ represents the number of tokens of the output token sequence predicted based on each input prompt input during the reinforcement learning process of the KV cache manager 300, and Bᵢ represents the number of tokens of the output token sequence actually output by the LLM 260 for each input prompt. In addition, N represents the number of iterations up to the current step.

Here, the KV cache manager 300 may set the size of the memory area assigned when scheduling the KV cache as large as the size of the buffer area. As learning continues based on input prompts further input during the learning process, the accuracy of the prediction increases and the value of ε in equation decreases, thereby more efficiently using the memory.

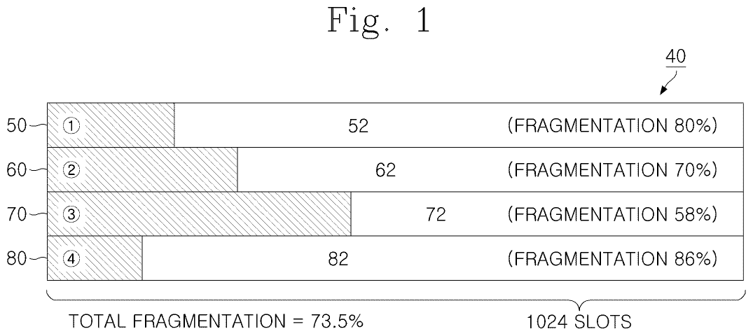

In the conventional technology illustrated in FIG. 1, only 4 prompts (input token sequence) can be processed in parallel as one batch for the same memory capacity, whereas, as illustrated in FIG. 6, in the KV cache management method proposed in the disclosure, each KV cache may be stored for a total of 10 prompts, so that up to 10 prompts (input token sequence) may be processed in parallel as one batch.

In the case of the example in FIG. 6, the memory waste per prompt corresponds to about the size of the buffer area (i.e., ε), and the total memory usage rate reaches 94.5%. As described above, it may be understood that the method proposed in the disclosure may increase the memory usage rate and increase the maximum number of prompts capable of being processed in parallel as one batch according thereto, thereby improving performance (throughput).

Furthermore, if an error occurs in the prediction of the KV cache manager 300, and if the number of tokens included in the output sequence actually output by the LLM 260 for each input prompt exceeds the number of tokens predicted by the KV cache manager 300 so that the allocated memory area is insufficient (for example, when the allocation area is insufficient for the KV caches of the exceeding tokens even with the buffer areas described above), an exception handling rule may be further defined in the management algorithm of the KV cache manager 300, for example, by processing additional allocation in the spare area 130 at the end of the memory 100, thereby avoiding interruption of services of the LLM 260.

Apparatus to which Proposed Method of Disclosure is Applicable

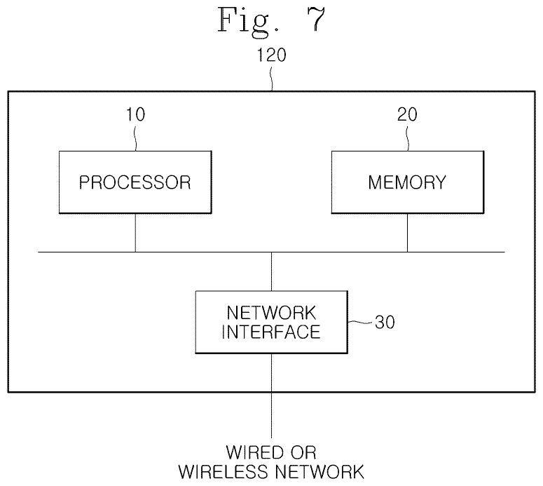

FIG. 7 illustrates an apparatus 120 capable of performing the proposed method of the disclosure.

Referring to FIG. 7, the apparatus 120 may be configured to implement the proposed method of the disclosure. For example, the apparatus 120 may be a computing device, a server device, a terminal device, or a network device for performing the process of the disclosure.

For example, the apparatus 120 to which the proposed method of the disclosure may be applied may include network devices such as repeaters, hubs, bridges, switches, routers, gateways, and the like, computer devices such as desktop computers, workstations, and the like, mobile terminals such as smartphones and the like, portable devices such as laptop computers and the like, home appliances such as digital TVs and the like, and vehicles such as automobiles and the like. As another example, the apparatus 120 to which the disclosure may be applied may be included as part of an ASIC (Application Specific Integrated Circuit) implemented in the form of an SoC (System-on-Chip).

The memory 20 may be connected to the processor 10 during operation, may store programs and/or instructions for processing and controlling the processor 10, and may store data and information used in the disclosure, control information required for processing data and information according to the disclosure, and temporary data generated during the data and information processing process. The memory 20 may be implemented as a storage device such as a ROM (Read-Only Memory), a RAM (Random Access Memory), an EPROM (Erasable Programmable Read-Only Memory), an EEPROM (Electrically Erasable Programmable Read-Only Memory), a flash memory, a SRAM (Static RAM), an HDD (Hard Disk Drive), an SSD (Solid State Drive), and the like.

The processor 10 may be operatively connected to the memory 20 and/or the network interface 30, and may control the operation of respective modules in the apparatus 120. In particular, the processor 10 may perform various control functions for performing the proposed method of the disclosure. The processor 10 may also be called a controller, a micro-controller, a micro-processor, a micro-computer, a GPU (graphics processing unit), or the like. The proposed method of the disclosure may be implemented by hardware, firmware, software, or a combination thereof. When implementing the disclosure using hardware, an ASIC (application specific integrated circuit) or a DSP (digital signal processor), a DSPD (digital signal processing device), a PLD (programmable logic device), an FPGA (field programmable gate array), or the like, configured to perform the disclosure, may be provided in the processor 10. Meanwhile, when implementing the proposed method of the disclosure using firmware or software, the firmware or software may include instructions related to modules, procedures, or functions that perform functions or operations necessary for implementing the proposed method of the disclosure, and the instructions may be stored in the memory 20 or stored in a computer-readable recording medium (not shown) separate from the memory 20, and may be configured to cause, when executed by the processor 10, the apparatus 120 to perform the proposed method of the disclosure.

In addition, the apparatus 120 may include a network interface device 30. The network interface device 30 may be connected to the processor 10 during operation, and the processor 10 may control the network interface device 30 to transmit or receive wireless/wired signals carrying information, data, signals, and/or messages through a wireless/wired network. The network interface device 30 may support various communication standards such as IEEE 802 series, 3GPP LTE(-A), 3GPP 5G, etc., and may transmit and receive control information and/or data signals according to the corresponding communication standards. The network interface device 30 may be implemented outside the apparatus 120 as needed.

The embodiments described above are implemented through a combination of the components and features of the disclosure in a predetermined manner. Each component or feature should be considered optional unless otherwise explicitly stated. Each component or feature may be implemented without connection with other components or features. In addition, it is also possible to configure the embodiments of the disclosure by combining some components and/or features. The sequence of operations described in the embodiments of the disclosure may be changed. Some components or features of an embodiment may be included in another embodiment, or may be replaced with corresponding components or features of another embodiment. It is obvious that claims that do not have an explicit citation relationship may be combined to form an embodiment or included as a new claim by amendment after filing.

### INDUSTRIAL APPLICABILITY

The disclosure may be applied to various devices such as computing devices, server devices, terminal devices, network devices, or the like to which a KV cache is applied for LLM serving based on a transformer model.

What is claimed is:

1. A method, performed in a computing device, for managing a KV cache for operation of a transformer model, the method comprising:
training a KV cache manager comprising a neural network, based on a plurality of input prompts of the transformer model and an output sequence of the transformer model for each input prompt;
predicting, by the trained KV cache manager, based on a first input prompt of the transformer model, the number of tokens to be included in a first output sequence of the transformer model for the first input prompt; and
determining a size of a KV cache for the first input prompt, based on the predicted number of tokens.

2. The method of claim 1,
wherein the training is performed such that a difference between the number of tokens of the output sequence predicted by the KV cache manager for each of the plurality of input prompts of the transformer model and the number of tokens of the output sequence of the transformer model actually output is reduced.

3. The method of claim 1,
wherein the training comprises:
determining a reward, based on a difference between the number of tokens of the output sequence predicted by the KV cache manager for each of the plurality of input prompts of the transformer model and the number of tokens of the output sequence of the transformer model actually output; and
training the neural network using reinforcement learning, based on the reward.

4. The method of claim 1,
further comprising further training the KV cache manager, based on the difference between the number of tokens predicted by the KV cache manager for the first input prompt and the number of tokens included in the first output sequence actually output by the transformer model.

5. The method of claim 1,
further comprising allocating a memory area corresponding to the KV cache for the first input prompt, based on the determined size of the KV cache,
wherein the memory area comprises a buffer area.

6. The method of claim 5,
wherein the size of the buffer area is variably adjusted based on a difference between the number of tokens predicted by the KV cache manager up to a previous step of a current step and the number of tokens included in an output sequence actually output by the transformer model.

7. The method of claim 1, further comprising:
allocating a memory area for the KV cache for the first input prompt, based on the determined size of the KV cache; and
further allocating a predetermined area of the memory in a case where the number of tokens included in the first output sequence actually output by the transformer model for the first input prompt exceeds the number of tokens predicted by the KV cache manager and where the allocated memory area is insufficient.

8. The method of claim 1, further comprising:
predicting, by the trained KV cache manager, based on a second input prompt of the transformer model, the number of tokens to be included in a second output sequence of the transformer model for the second input prompt;
determining a size of a KV cache for the second input prompt, based on the predicted number of tokens;
allocating a memory area for each of the KV cache for the first input prompt and the KV cache for the second input prompt, based on the determined sizes thereof; and
causing the transformer model to process the first input prompt and the second input prompt in parallel.

9. An apparatus comprising:
a processor; and
a memory,
wherein the memory comprises instructions configured to cause, when executed by the processor, the apparatus to implement specific operations for managing a KV cache for operation of a transformer model, and
wherein the specific operations comprise:
training a KV cache manager comprising a neural network, based on a plurality of input prompts of the transformer model and an output sequence of the transformer model for each input prompt;
predicting, by the trained KV cache manager, based on a first input prompt of the transformer model, the number of tokens to be included in a first output sequence of the transformer model for the first input prompt; and
determining a size of a KV cache for the first input prompt, based on the predicted number of tokens.

10. The apparatus of claim 9,
wherein in the training,
a difference between the number of tokens of the output sequence predicted by the KV cache manager for each of the plurality of input prompts of the transformer model and the number of tokens of the output sequence of the transformer model actually output is reduced.

11. The apparatus of claim 9,
wherein the training comprises:
determining a reward, based on a difference between the number of tokens of the output sequence predicted by the KV cache manager for each of the plurality of input prompts of the transformer model and the number of tokens of the output sequence of the transformer model actually output; and
training the neural network using reinforcement learning, based on the reward.

12. The apparatus of claim 9,
wherein the specific operations further comprise further training the KV cache manager, based on the difference between the number of tokens predicted by the KV cache manager for the first input prompt and the number of tokens included in the first output sequence actually output by the transformer model.

13. The apparatus of claim 9,
wherein the specific operations further comprise allocating a memory area corresponding to the KV cache for the first input prompt, based on the determined size of the KV cache, and
wherein the memory area comprises a buffer area.

14. The apparatus of claim 13,
wherein the size of the buffer area is variably adjusted based on a difference between the number of tokens predicted by the KV cache manager up to a previous step of a current step and the number of tokens included in an output sequence actually output by the transformer model.

15. The apparatus of claim 9,
wherein the specific operations further comprise:
allocating a memory area for the KV cache for the first input prompt, based on the determined size of the KV cache; and
further allocating a predetermined area of the memory in a case where the number of tokens included in the first output sequence actually output by the transformer model for the first input prompt exceeds the number of tokens predicted by the KV cache manager and where the allocated memory area is insufficient.

16. The apparatus of claim 9,
wherein the specific operations further comprise:
predicting, by the trained KV cache manager, based on a second input prompt of the transformer model, the number of tokens to be included in a second output sequence of the transformer model for the second input prompt;
determining a size of a KV cache for the second input prompt, based on the predicted number of tokens;
allocating a memory area for each of the KV cache for the first input prompt and the KV cache for the second input prompt, based on the determined sizes thereof; and
causing the transformer model to process the first input prompt and the second input prompt in parallel.
